(19) United States
(12) Patent Application Publication
(10) Pub. No.: US 2007/0140306 A1
(43) Pub. Date: Jun. 21, 2007

(54) Identifying existence and rate of jitter during real-time audio and video streaming

(75) Inventor: Paul Fredric Klein, Newbury Park, CA (US)

Correspondence Address: INTERNATIONAL BUSINESS MACHINES CORP., IP LAW, 555 BAILEY AVENUE, J46/G4, SAN JOSE, CA, 95141, US

(73) Assignee: International Business Machines Corporation

(21) Appl. No.: 11/303,805

(22) Filed: Dec. 16, 2005

(51) Int. Cl. H04J 3/06

(52) U.S. Cl. 370/516; 370/508

(57) ABSTRACT

Various embodiments of a computer-implemented method, system and computer program product identify jitter in a multimedia datastream comprising packets which are sent from a web server in a web server computer to a client computer. An agent in the web server computer computes packet intervals associated with the packets which are sent from the web server. The agent determines whether jitter is occurring at the client computer receiving the packets based on the packet intervals. In some embodiments, a jitter rate is determined based on the packet intervals.

### BACKGROUND OF THE INVENTION

1.0 Field of the Invention

This invention relates to performance monitoring; and in particular, this invention relates to identifying the existence and rate of jitter during real-time audio and video streaming.

2.0 Description of the Related Art

Audio and video streaming over the Internet is becoming an important feature of web sites. Once thought of as a gimmick for gaming and entertainment only, audio and video streaming is fast becoming a way to disseminate important information to a large number of people in a non-textual format. For example, a large corporation may provide announcements via streaming audio and video over the Internet, rather than using a mass mailing. The economics makes audio and video streaming over the Internet very attractive.

In streaming audio and video, a web server sends a datastream comprising a sequence of packets comprising audio and video data, respectively, to a web browser. The web browser plays the audio and video data from the received packets. The quality of the audio and/or video which is played at the web browser has a significant impact in the effectiveness of the streaming. The architecture of streaming audio and video is designed such that the packets of the datastream are expected to propagate through the network to the web browser at a certain rate. One problem with streaming audio and video over a network such as the Internet is variation in the amount of time for the packets to propagate through the network to the web browser. If the packets take too long to propagate to the web browser, the resulting audio and video data played at the web browser may manifest jitter. In video data, jitter is manifested as a shaky image. In audio data, jitter may be manifested as a shuddering sound. Jitter is unacceptable in an audio and/or video datastream because recipients may not continue to listen to or watch that audio and/or video datastream, respectively, for long.

One solution would be to measure jitter at the web browser receiving the audio and video datastream. However, such a solution would involve installing software at a recipient's computer. Solutions that have technology and software located at the recipient's web browser have to take the additional steps of installing the technology at the web browser and collecting the data from the web browser after the measurements are taken. In a commercial environment, such steps may be considered intrusive to the recipient and accomplishing them may be a difficult and not always successful endeavor. Therefore, there is a need for an improved technique to identify the existence and rate of jitter in an audio or video datastream.

### SUMMARY OF THE INVENTION

To overcome the limitations in the prior art described above, and to overcome other limitations that will become apparent upon reading and understanding the present specification, various embodiments of a computer-implemented method, system and computer program product identify jitter in a multimedia datastream comprising packets which are sent from a web server in a web server computer to a client computer. An agent in the web server computer computes packet intervals associated with the packets which are sent from the web server. The agent determines whether jitter is occurring at the client computer receiving the packets based on the packet intervals. In some embodiments, a jitter rate is determined based on the packet intervals.

In this way, various embodiments of a technique are provided which identify the existence of jitter, and in some embodiments, the rate of jitter in a datastream.

### BRIEF DESCRIPTION OF THE DRAWINGS

The teachings of the present invention can be readily understood by considering the following description in conjunction with the accompanying drawings, in which:

FIG. 1 depicts an illustrative diagram of a web server computer, a client computer and a network, suitable for use with the present invention;

FIG. 2 depicts a block diagram of an embodiment illustrating various components which are stored in the memory of the web server computer of FIG. 1;

FIG. 3 depicts a block diagram of an embodiment of a timing array which is stored in the memory of FIG. 2;

FIG. 4 comprises FIGS. 4A, 4B and 4C which collectively depict a flowchart of an embodiment of a technique to identify the existence and rate of jitter;

FIG. 5 depicts a flowchart of an embodiment of determining a jitter threshold;

FIG. 6 depicts a flowchart of an embodiment of providing jitter information to a provider;

FIG. 7 depicts an exemplary timing array;

FIG. 8 depicts a diagram of an exemplary graphical user interface which displays an illustrative sequence of packets of a datastream based on the exemplary timing array of FIG. 7;

FIG. 9 depicts a diagram of an exemplary graphical user interface which displays packet intervals and jitter indicators for the illustrative sequence of packets of FIG. 8;

FIG. 10 depicts a diagram of an exemplary graphical user interface which displays a jitter indicator and a jitter rate percentage based on the illustrative sequence of packets of FIG. 8;

FIG. 11 depicts a diagram of an exemplary graphical user interface which displays a jitter indicator associated with a packet along a time line based on the timestamp of the packet based on the timing array of FIG. 7; and

FIG. 12 depicts an illustrative computer system which uses various embodiments of the present invention.

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to identify jitter in a datastream. Various embodiments of a computer-implemented method, system and computer program product identify jitter in a multimedia datastream comprising packets which are sent from a web server in a web server computer to a client computer. An agent in the web server computer computes packet intervals associated with the packets which are sent from the web server. The agent determines whether jitter is occurring at the client computer receiving the packets based on the packet intervals. In some embodiments, a jitter rate is determined based on the packet intervals.

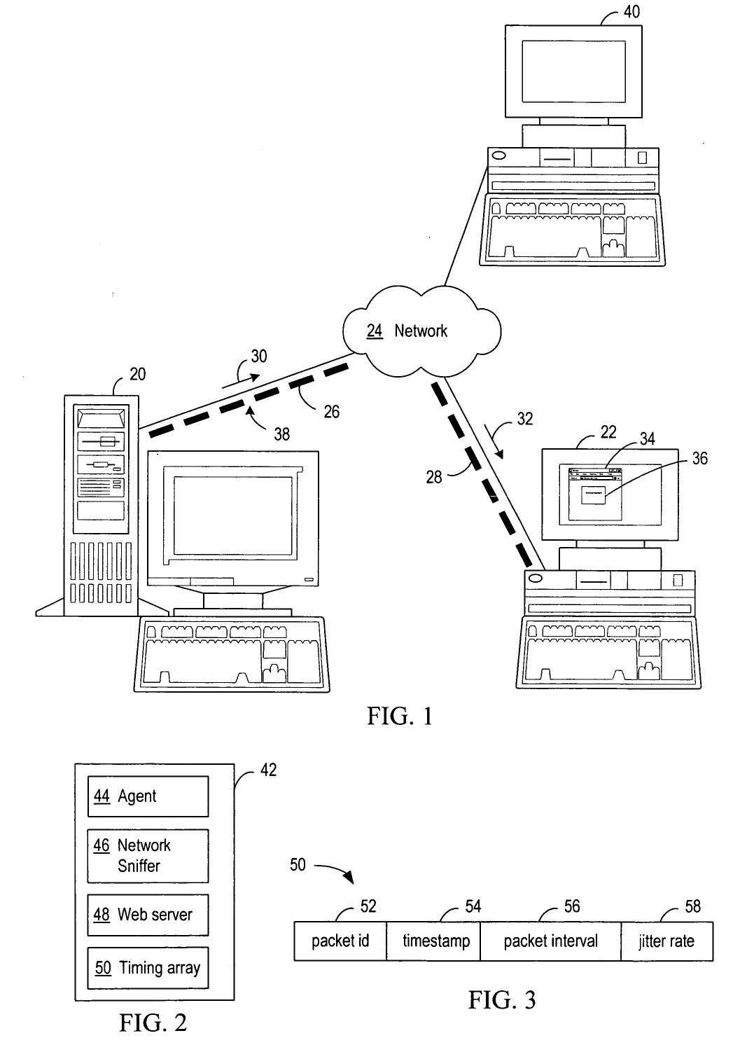

FIG. 1 depicts an illustrative diagram of a web server computer 20, a client computer 22 and a network 24, suitable for use with the present invention. The web server computer 20 and client computer 22 are coupled to the network 24. In various embodiments, the network 24 is the Internet. However, the network 24 is not meant to be limited to the Internet, and other networks may be used. The web server computer 20 is sending a datastream of packets 26, 28 comprising multimedia data to the client computer 22. Arrows 30, 32 indicate the direction of transmission of the packets from the web server computer 20 to the client computer 22. The term “multimedia” refers to audio, video or a combination of audio and video. The client computer 22 is executing a web browser 34 which is playing the multimedia data of the packets. For example, video data may be playing in a window 36 of the web browser 34 for a recipient. The packets are typically separated by a period of time 38. In some embodiments, the web browser 34 is a multimedia player. In other embodiments, the web browser 34 comprises a media player.

In various embodiments, jitter at the client computer is identified at the web server 20 based on an analysis of the multimedia datastream. In other embodiments, jitter is identified at another computer 40, external to the web server 20 and the client computer 22.

FIG. 2 depicts a block diagram of an embodiment illustrating various components which are stored in the memory 42 of the web server computer 20 of FIG. 1. In various embodiments, the memory 42 stores an agent 44, a network sniffer 46, a web server 48 and a timing array 50. The web server 48 sends the packets in the datastream to the web browser 34 (FIG. 1). In various embodiments, the network sniffer 46 is inserted between the web server 48 and the client's web browser. In some embodiments, the network sniffer 46 is logically inserted between the web server 48 and the client's web browser. The packets which are sent by the web server 48 pass through the network sniffer 46 as they propagate to the client computer 22 (FIG. 1). In response to the arrival of a packet at the network sniffer 46, the network sniffer 46 makes a copy of that packet. The network sniffer 46 provides a timestamp indicating the time of the arrival of the packet at the network sniffer 46 and the packet identifier to the agent 44. In various embodiments, the network sniffer 46 is a software module in the web server computer. In other embodiments, the network sniffer is a separate device that is connected to the network at the web server computer and provides the timestamps and packet ids to the agent 44. In some embodiments, the network sniffer is a device that is physically connected to the network, in other embodiments, the network sniffer is wireless device. In this description, the phrase “network sniffer at the web server computer” refers to a network sniffer in the web server computer or a network sniffer which is a device that is external to the web server computer but coupled to the network at the same location as the web server computer, and in some embodiments, a network sniffer which is a device that is in a different location from the web server computer. In another embodiment, the agent 44, network sniffer 46 and timing array 50 of the memory 42 are stored on the external computer 40 of FIG. 1.

FIG. 3 depicts a block diagram of an embodiment of the timing array 50 which is stored in the memory of FIG. 2. The timing array 50 stores data from which jitter is identified. In response to the arrival of a packet at the network sniffer 46 (FIG. 2), the agent 44 (FIG. 2) stores the packet identifier (id) 42, the timestamp 54 of the arrival of the packet at the network sniffer, and a packet interval 56 in the timing array 50. The packet interval 56 indicates an amount of time between the arrival of consecutive packets at the network sniffer 46 (FIG. 2). For example, in various embodiments, the packet interval associated with the current packet is equal to the difference between the timestamp of the current packet and the timestamp of the previous packet. In some embodiments, the timing array also comprises a jitter rate 58; in other embodiments, the jitter rate 58 is omitted.

Streaming technology makes use of a buffer that typically resides at the web browser on the client computer. The buffer is a local storage area in the client computer which stores multimedia data from one or more received packets, which is waiting to be played, while the multimedia data of an earlier packet is being played. As long as the buffer contains multimedia data waiting to be played, the multimedia data plays jitter free.

Because of the buffer, packets typically arrive at the web browser one after the other at a substantially constant steady-state rate. If the buffer fills up, the web browser sends a request to the web server to stop the web server from sending more packets. At this point, the transmission of packets containing the multimedia data stops until the web server receives a request from the web browser for more packets. These network streaming start and stop events are controlled by corresponding web browser requests.

The web server computer and client computer typically use the well-known Transmission Control Protocol/Internet Protocol (TCP/IP) to send and receive packets, respectively. TCP/IP uses a network handshaking technique to send and acknowledge receipt of packets. Using TCP/IP, the web server computer sends one or more packets to the client computer. In response to receiving the one or more packets, the client computer sends an acknowledgement to indicate to the web server computer that the one or more packets are received and that more packets can be sent.

Typically, the packets are sent to the web browser sequentially and the packets typically have a substantially constant steady-state rate of transmission; therefore, the packet intervals are typically substantially the same. When the packet intervals exceed a threshold, not caused by stop and start requests from the web browser, then jitter may be occurring because the packets may not be arriving at the web browser at a sufficient rate such that the multimedia data of at least one packet is waiting in the buffer to be played. When the buffer is empty, the web browser becomes dependent on playing the multimedia data of the packets directly as the packets arrive.

Jitter typically occurs because of a bad or slow network link to the client computer. When the network link is bad or slow, the packets may take a long time to reach the client computer and therefore the handshaking may be slow. Therefore, if the buffer is empty, the browser may have to wait for a packet to arrive, and the playing of the multimedia data is temporarily halted until the next packet arrives. Therefore the jitter may be visible and/or audible to the user at the client computer.

The inventor realized that the condition that caused the buffer at the web browser to become empty implies that the web server cannot send the packets fast enough for the multimedia data to be played without visible and/or audible jitter, and that the existence of visible and/or audible jitter at the web browser is also manifested in the form of long packet intervals at the web server computer. Various embodiments of the present invention use the packet intervals at the web server computer to determine, that is, predict, whether visible and/or audible jitter is occurring at the client computer. The term “manifest jitter” refers to visible jitter, audible jitter or a combination of visible and audible jitter.

In various embodiments, the existence of jitter at a client computer, and in some embodiments, a jitter rate at the client computer, is determined based on the packet intervals from the web server's point of view. In various embodiments, jitter, and in some embodiments manifest jitter, is determined to be occurring at the client computer in response to a packet interval exceeding a jitter threshold at the web server computer. For example, in some embodiments, a packet interval that exceeds a jitter threshold equal to 30% above an average packet interval indicates the existence of manifest jitter. However, the frequency of the occurrence of jitter may also be a factor in determining whether jitter is a problem. For example, if the packet interval exceeds the jitter threshold only once in the entire transmission of the datastream, jitter may not be considered to be a problem. In another example, if the packet intervals exceed the jitter threshold for 25% of the packets of the datastream, jitter may be considered to be a problem. In this way, a determination of the existence and rate of manifest jitter in a web browser of a client computer can be made without installing additional software on the client computer.

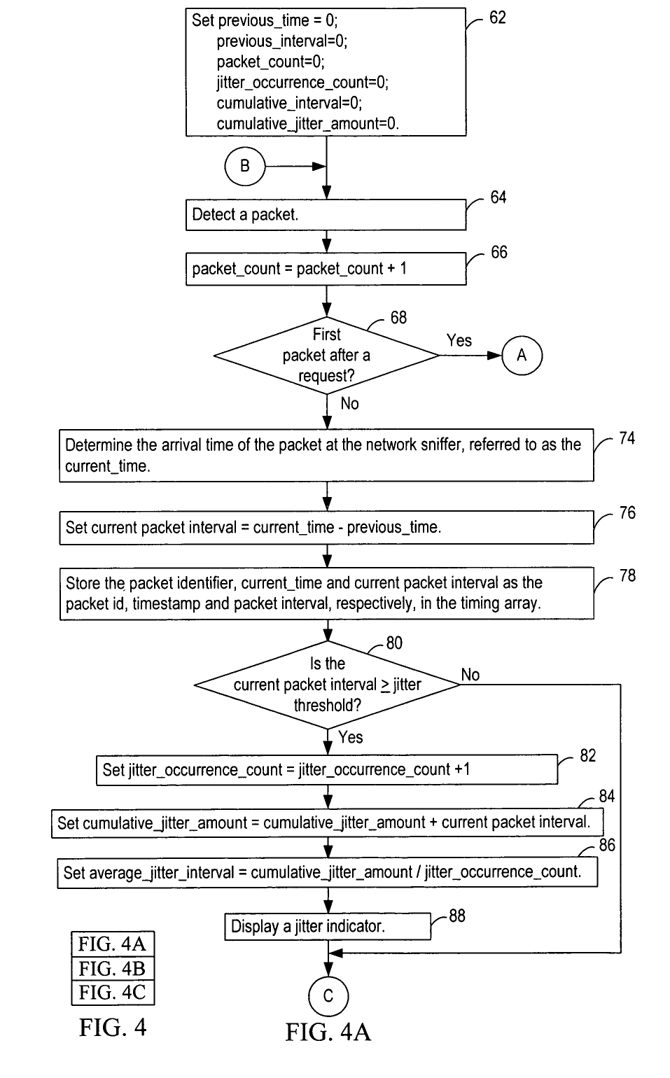

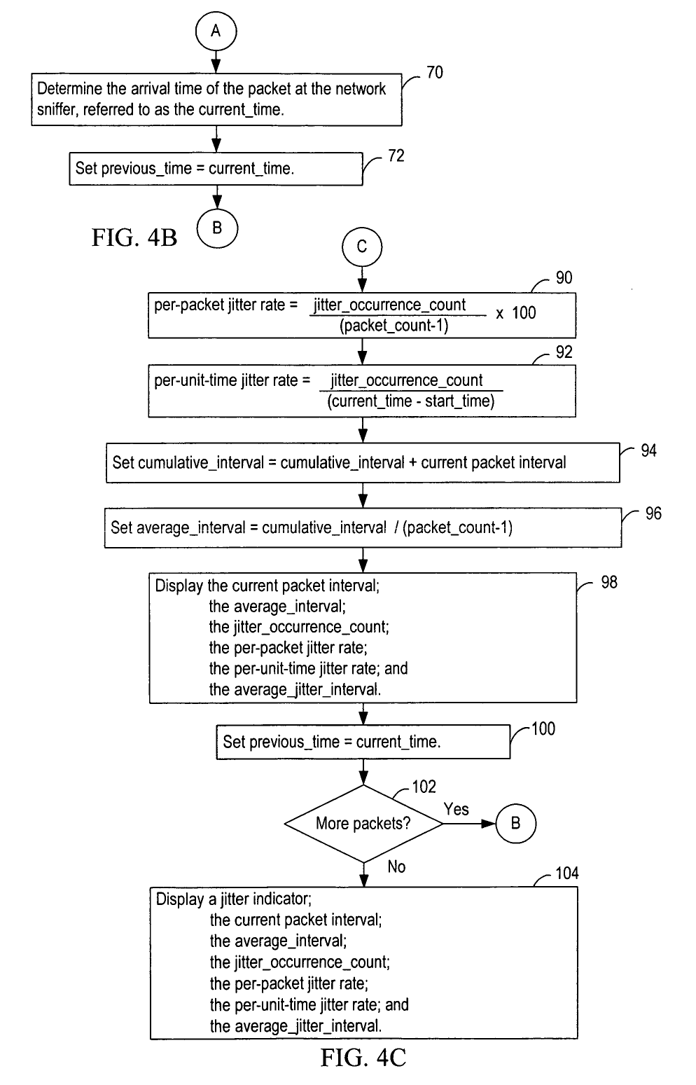

FIG. 4 comprises FIGS. 4A, 4B and 4C which collectively depict a flowchart of an embodiment of a technique to identify the existence and rate of jitter, and in various embodiments, manifest jitter. In various embodiments, the flowchart of FIG. 4 may be implemented in the agent 44 of FIG. 2.

In step 62, the agent sets the variables previous_time, previous_interval, packet_count, jitter_occurrence_count, cumulative_interval, and cumulative_jitter_amount equal to zero. The variable previous_time stores the timestamp indicating the arrival time of the previous packet at the network sniffer. The variable previous_interval stores the packet interval associated with the previous packet. The cumulative_jitter_amount is used to determine the average of the packet intervals which are determined to have jitter.

In step 64, the agent, typically via the network sniffer, detects a packet from the web server. In step 66, the packet_count is incremented by one.

Step 68 determines whether the packet is a first packet after a request from the web browser for packets. If so, step 68 proceeds via Continuator A to step 70 of FIG. 4B. In step 70, the arrival time of the packet at the network sniffer, referred to as the current_time is determined. The time is typically a timestamp and is provided to the agent by the network sniffer. In step 72, the previous_time is set equal to the current_time. In this way, the amount of time between the last packet sent prior to receiving a request from the web browser to stop sending packets and the first packet sent in response to a request from the web browser to start sending packets is excluded from jitter identification and measurement. Step 72 proceeds via Continuator B to step 64 of FIG. 4A.

In step 64, the agent detects another packet from the web server, and in step 66, the packet_count is incremented by one. Step 68 determines whether the packet is the first packet after a request from the web browser for packets. If not, in step 74, the agent determines, that is, receives, the arrival time of the packet at the network sniffer, referred to as current_time. In step 76, the agent sets the current packet interval equal to the current_time minus the previous_time. In step 78, the agent stores the packet identifier, current_time and current packet interval as the packet id, timestamp and packet interval, respectively, in the timing array. In step 80, the agent determines whether the current packet interval is greater than or equal to a jitter threshold. If so, jitter, and in various embodiments, manifest jitter, is determined to be occurring and, in step 82, the agent increments the jitter occurrence_count by one. In step 84, the cumulative_jitter_amount is set equal to the cumulative_jitter_amount plus the current packet interval. In step 86, the average_jitter_interval is set equal to the cumulative_jitter_amount divided by the jitter_occurrence_count.

In step 88, the agent displays a jitter indicator. In some embodiments, a jitter magnitude is determined, such that the jitter magnitude is equal to the current packet interval minus the jitter threshold, and the jitter indicator is proportional to the jitter magnitude. In various embodiments, the jitter magnitude is displayed. Step 88 proceeds via Continuator C to step 90 of FIG. 4C.

In step 90 of FIG. 4C, the agent determines a per-packet jitter rate. In various embodiments, the per-packet jitter rate is expressed as a percentage. The per-packet jitter rate is set equal to the jitter_occurrence_count divided by the packet_count minus one, and multiplied by 100.

In step 92, the agent determines a per-unit-time jitter rate. The per-unit-time jitter rate is set equal to the jitter_occurrence_count divided by the difference between the current_time and the start_time.

In step 94, the agent sets the cumulative_interval equal to the cumulative_interval plus the current packet interval. In step 96, the agent sets the average_interval equal to the cumulative_interval divided by (packet_count-1). In step 98, the agent displays the current packet interval, the average interval, the jitter_occurrence_count, the per-packet jitter rate, the per-unit-time jitter rate, and the average_jitter_interval. In step 100, the agent sets the previous_time equal to the current_time. In step 102, the agent determines whether there are more packets. If so, step 102 proceeds via Continuator B to step 64 of FIG. 4A to detect another packet.

In response to step 102 determining that there are no more packets, in step 104, the agent displays the jitter indicator, the average_interval, the current packet interval, the jitter_occurrence_count, the per-packet jitter rate, the per-unit-time jitter rate, and the average_jitter_interval. In some embodiments, in step 104, the agent displays at least one or any combination of: the average_interval, the current packet interval, the jitter_occurrence_count, the per-packet jitter rate, and the per-unit-time jitter rate for the entire duration of the datastream. In other embodiments, in step 104, the agent displays at least one or any combination of: the average_interval, the current packet interval, the jitter_occurrence_count, the per-packet jitter rate, and the per-unit-time jitter rate for less than all the packets of the datastream.

In this way, the agent at the web server determines whether jitter, and in various embodiments, visible and/or audible jitter, is occurring remotely at the web browser playing the multimedia data of the datastream at the client computer. Various embodiments determine whether visible and/or audible jitter is occurring in a multimedia datastream without placing any technology or software in the client computer receiving the datastream. Using the agent at the web server computer, a provider of a multimedia datastream can access the jitter information without communicating with the recipient's web browser or computer.

In some embodiments, the packet intervals which are determined to have jitter are compared to an average of the packet intervals which are determined to be normal, to determine whether the jitter is short or long. In some embodiments, the average of the packet intervals which are determined to be normal is equal to the average packet interval for a plurality of packets of a datastream, or portion of a datastream, which is determined to be jitter-free by the sender or provider.

In various embodiments, the jitter determination is performed during the life of the datastream, that is, from the start of the datastream to the end of the datastream. In other embodiments, the jitter determination is performed for a portion of the datastream.

In some embodiments, step 90 is omitted and steps 98 and 104 do not display the per-packet jitter rate. In other embodiments, step 92 is omitted and steps 98 and 104 do not display the per-unit-time jitter rate. In other embodiments, steps 98 and 104 display at least one and any combination of the current packet interval, the average interval, the jitter_occurrence_count, the per-packet jitter rate, and the per-unit-time jitter rate. In yet other embodiments step 98 is omitted. In some embodiments, step 104 is omitted. In other embodiments, step 88 is omitted. In other embodiments, steps 90 and 92 also store the jitter rate in the timing array.

In another alternate embodiment, the packet count is not incremented in response to receiving a first packet after a request for packets from the web browser. In this embodiment, step 66 is performed in the “No” branch of step 68, for example, after step 74 and prior to step 76. In this embodiment, in FIG. 4C, in step 90, the per-packet jitter rate is equal to the jitter_occurrence_count divided by the packet_count, and multiplied by 100; and in step 96, the average_interval is equal to the cumulative_interval divided by the packet_count.

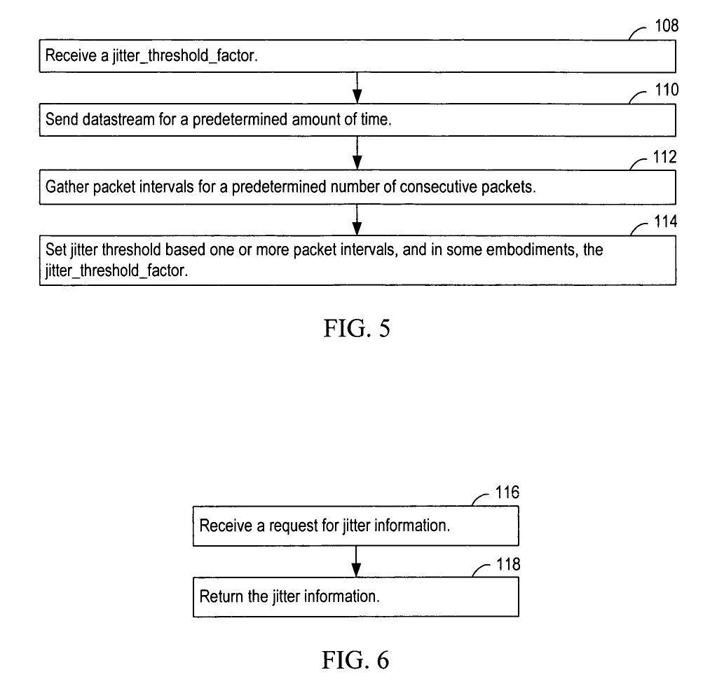

FIG. 5 depicts a flowchart of an embodiment of determining the jitter threshold. In step 108, a jitter_threshold_factor is received. In some embodiments, a user sets the jitter_threshold_factor. In other embodiments, a predetermined jitter_threshold_factor is used. In step 110, the datastream is sent for a predetermined amount of time. Therefore, the datastream should be in a steady-state. In step 112, packet intervals are gathered for a predetermined number of packets. Alternately, packet intervals are gathered for a predetermined amount of time.

In step 114, the jitter threshold is set based on one or more of the packet intervals, and in some embodiments, the jitter_threshold_factor. In various embodiments, the jitter threshold is set equal to the average value of the packet intervals, and in some embodiments, equal to the average value of the packet intervals multiplied by the jitter threshold_factor. In other embodiments, the jitter threshold is set equal to the maximum value of the packet intervals, and in some embodiments, the maximum value of the packet intervals multiplied by the jitter_threshold_factor. In yet other embodiments, the jitter threshold is set equal to the mean value of the packet intervals, and in some embodiments, the mean value of the packet intervals multiplied by the jitter_threshold_factor. In other alternate embodiments, the jitter threshold is set equal to the minimum value of the packet intervals multiplied by the jitter_threshold_factor.

In an alternate embodiment, in step 110, a first predetermined number of packets are sent, and in step 112 the packet intervals are gathered for a second predetermined number of packets. In yet another alternate embodiment, the flowchart of FIG. 5 is not performed, and the jitter threshold is set to a predetermined value. In some embodiments, the jitter threshold is set to a predetermined value by a user.

In another embodiment, a multimedia stream for a provider comprises multiple datastreams which are sent to different clients at different client computers. In this embodiment, the average packet interval is computed using the packet intervals between the outbound packets for each of the datastreams to the different clients. The overall average packet interval is then calculated based on the average packet interval for each client. The datastreams which have an average packet interval that exceeds the overall average packet interval are considered to have jitter, and in various embodiments, are considered to have manifest jitter.

In yet another embodiment, an overall average packet interval is calculated based on all datastreams to all clients of the web server computer. Those clients' datastrearns which have a packet interval, or alternately, average packet interval, that is greater than the overall average packet interval are considered to have jitter in their datastream.

In another alternate embodiment, one or more test datastreams are sent to one or more clients, and the jitter threshold is set equal to the average packet interval based on all of the one or more of the test datastreams to all of the one or more clients.

Based on an analysis of the jitter in the multimedia datastream, as measured from the web server's point-of-view, a determination of quality provided by multimedia providers can be achieved. In various embodiments, a multimedia provider wants to monitor the quality of the datastream.

FIG. 6 depicts a flowchart of an embodiment of providing jitter information. In some embodiments, the flowchart of FIG. 6 is also performed by the agent. In step 116, a request is received for jitter information. In step 118, jitter information is returned in response to the request. The jitter information comprises at least one or any combination of the following: the average_interval, the current packet interval, the jitter_occurrence_count, the per-packet jitter rate, the per-unit-time jitter rate, the average_jitter, jitter magnitude, and jitter threshold. The jitter information may be for a single datastream, portion of a datastream, or for multiple datastreams.

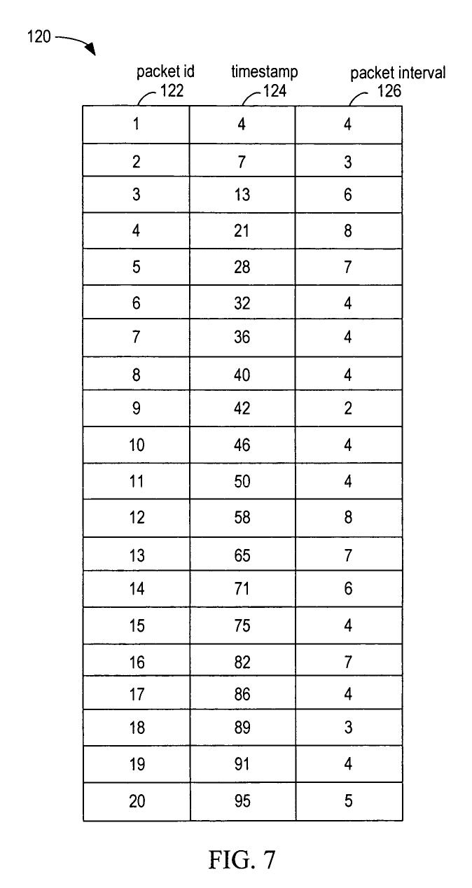

FIG. 7 depicts an exemplary timing array 120. The timing array 120 has a packet identifier (id) 122, timestamp 124 and packet interval 126. The timestamp 124 is illustrative and represents a time in milliseconds, in practice the timestamp comprises month, day, year, hour, second and millisecond data. However, other formats for the timestamp may be used. Typically, the timestamp measures at least to the millisecond level.

For example, packet identifier 1 has a timestamp of 4 milliseconds and a packet interval of 4 milliseconds from the arrival of a previous packet at the network sniffer. Packet identifier 2 has a timestamp of 7 milliseconds and a packet interval of 3 milliseconds from the arrival of packet identifier 1 at the network sniffer.

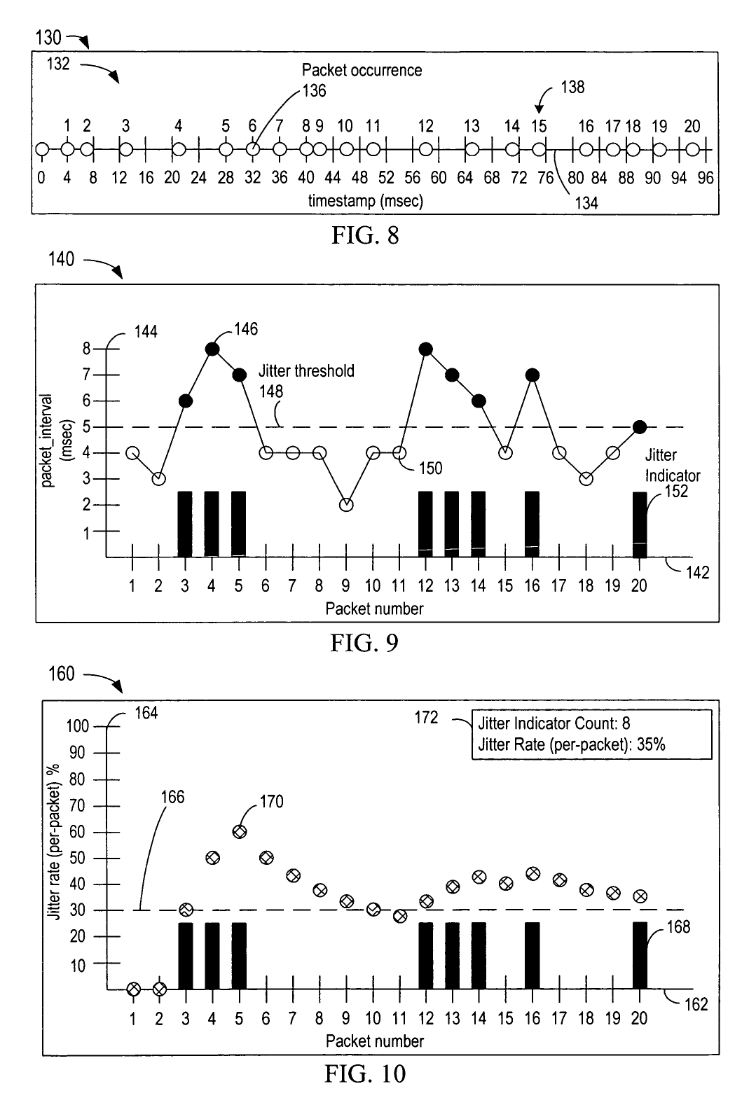

FIG. 8 depicts a diagram of an exemplary graphical user interface 130 which displays an illustrative sequence of packets 132 of a datastream based on the exemplary timing array 120 of FIG. 7. In some embodiments, the graphical user interface of FIG. 8 is displayed in at least one of steps 98 and 104 of FIG. 4. The x-axis 134 depicts the time, in milliseconds (msec). Each circle 136 represents an occurrence of a packet. Each number 138 above a circle 136 represents a packet number. In this example, the packet number 138 is the same as the packet id. Alternately, the packet number 138 represents the packet's position in a sequence of packets in a monitored datastream, with packet number 1 referring to the first packet having a packet interval in the datastream. As illustrated in FIG. 8, the packet interval, that is, the amount of time, between consecutive packets varies.

FIG. 9 depicts a diagram of a graphical user interface 140 which displays the packet intervals and jitter indicators for the illustrative sequence of packets of FIG. 8. In some embodiments, the graphical user interface of FIG. 9 is displayed in at least one of steps 98 and 104 of FIG. 4. In other embodiments, the jitter indicators are displayed in step 88 of FIG. 4. The x-axis 142 represents the packet number. The y-axis 144 represents the packet interval in msec. Each circle 146 represents a packet interval. The dashed line 148 represents the jitter threshold. In various embodiments, when the packet interval is less than the jitter threshold 146, the circle 150 is white, or alternately, has a first color. In response to a packet interval exceeding the jitter threshold 148, a jitter indicator is displayed. In some embodiments, a distinct visual indicator is applied to the circle 146. For example, the circle 146 is darkened or shaded, or a second color, different from the first color, is applied to the circle, or a distinct pattern may be applied to the circle. In another embodiment, the jitter indicator is a distinct bar 152 associated with a packet number. In yet another embodiment, the height of the bar is equal to, or alternately, proportional to, the jitter magnitude.

FIG. 10 depicts a diagram of a graphical user interface 160 which displays a jitter indicator and a per-packet jitter rate percentage based on the illustrative sequence of packets of FIG. 8. In some embodiments, the graphical user interface of FIG. 10 is displayed in at least one of steps 98 and 104 of FIG. 4. In other embodiments, the jitter indicators are displayed in step 88 of FIG. 4. The x-axis 162 represents the packet number. The y-axis 164 represents the per-packet jitter rate as a percentage. The dashed line 166 represents a jitter alert threshold. The jitter indicator associated with a packet is shown with a bar 168. Each circle 170 represents the cumulative per-packet jitter rate percentage up to the associated packet number. A measurement text box 172 displays the jitter occurrence count and cumulative jitter rate as of the most recent packet, in this example, packet number 20. In some embodiments, in response to the jitter rate exceeding the jitter alert threshold, a distinct visual indicator may be displayed, for example, the cumulative jitter rate in the measurement text box 172 may be flashed, or the cumulative jitter rate in the measurement text box 172 may be displayed with a distinct color.

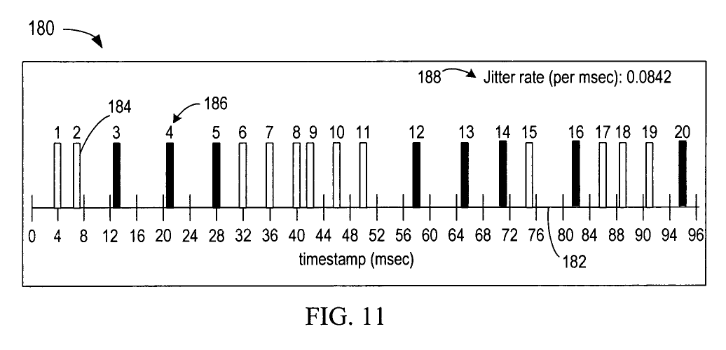

FIG. 11 depicts a diagram of a graphical user interface 180 which displays a packet arrival and a jitter indicator associated with that packet along a time line based on the timestamp based on the timing array 120 of FIG. 7. In some embodiments, the graphical user interface of FIG. 11 is displayed in at least one of steps 98 and 104 of FIG. 4. In other embodiments, the jitter indicators are displayed in step 88 of FIG. 4. The x-axis 182 represents a timestamp in msec. In this example, the occurrence of a packet is associated with a bar 184, and the packet number 186 is displayed above the bar. The jitter rate per unit time, in this example, the cumulative jitter rate per millisecond 188 is displayed for the most recent packet. In other embodiments, the jitter rate per unit time is plotted along a y-axis.

In various embodiments, the graphical user interfaces of FIGS. 8, 9, 10 and 11 are displayed on the web server computer. In some embodiments, the graphical user interfaces of FIGS. 8, 9, 10 and 11 are displayed on a remote computer, that is, a computer other than the web server computer. In some embodiments, the remote computer is not a client computer receiving the datastream; in other embodiments, the remote computer is also a client computer receiving the datastream. In this way, a provider may monitor the quality of the datastream either at the web server computer or remotely.

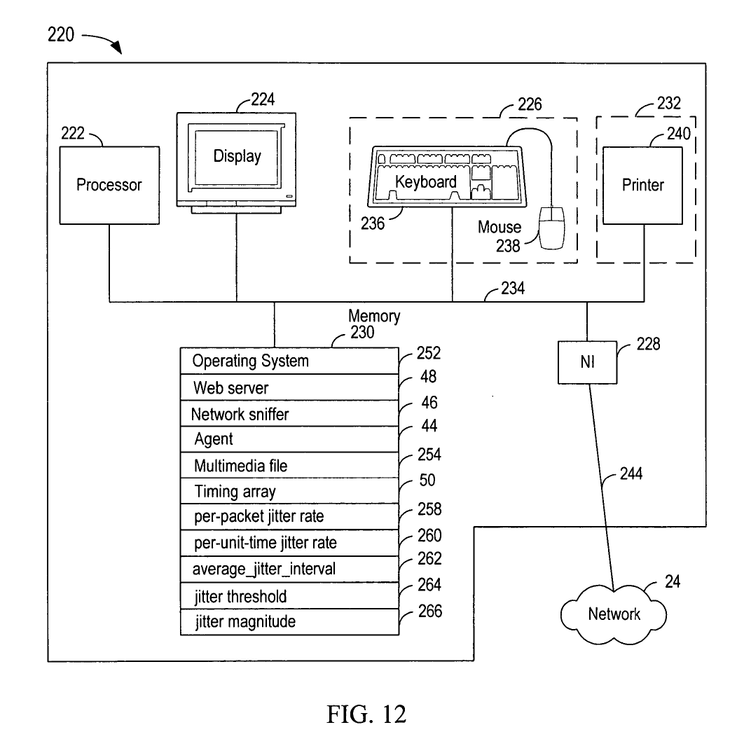

FIG. 12 depicts an illustrative computer system 220 which uses various embodiments of the present invention. In various embodiments the computer system 220 is the web server computer of FIG. 1. The computer system 220 comprises a processor 222, display 224, input interfaces (I/F) 226, communications interface 228, memory 230 and output interface(s) 232, all conventionally coupled, directly or indirectly, by one or more buses 234. The input interfaces 226 comprise at least one of keyboard 236 and a pointing device such as a mouse 238. The output interface 232 comprises a printer 240. The communications interface 228 is a network interface (NI) that allows the computer 220 to communicate via the network 24, such as the Internet. The communications interface 228 may be coupled to a transmission medium 244 such as a network transmission line, for example twisted pair, coaxial cable or fiber optic cable. In another embodiment, the communications interface 228 provides a wireless interface, that is, the communications interface 228 uses a wireless transmission medium.

The memory 230 generally comprises different modalities, illustratively volatile memory such as semiconductor memory, such as random access memory (RAM), and persistent or non-volatile memory, such as, disk drives. In some embodiments, the memory 230 comprises local memory which is employed during execution of the program code, bulk storage, and one or more cache memories which provide temporary storage of at least some program code in order to reduce the number of times code is retrieved from bulk storage during execution. In various embodiments, the memory 230 stores an operating system 252, the web server 48, the network sniffer 46, the agent 44, a multimedia file 254, the timing array 50, the per-packet jitter rate 258, the per-unit-time jitter rate 260, the average jitter interval 262, the jitter threshold 264, and, in some embodiments, the jitter magnitude 266. The multimedia file 254 comprises multimedia data which is sent by the web server 48, in packets, to a client computer.

In various embodiments, the specific software instructions, data structures and data that implement various embodiments of the present invention are typically incorporated in the agent 44 and, in some embodiments, the timing array 50, and in various embodiments, the per-packet jitter rate 258, the per-unit-time jitter rate 260, the average jitter interval 262, jitter threshold 264, and, in some embodiments, the jitter magnitude 266. Generally, an embodiment of the present invention is tangibly embodied in a computer-readable medium, for example, the memory 230 and is comprised of instructions which, when executed by the processor 222, causes the computer system 220 to utilize the present invention. The memory 230 may store the software instructions, data structures and data for any of the operating system 252, the web server 48, the network sniffer 46, the agent 44, the multimedia file 254, the timing array 50, the per-packet jitter rate 258, the per-unit-time jitter rate 260, the average jitter interval 262, the jitter threshold 264, and, in some embodiments, the jitter magnitude 266, in semiconductor memory, in disk memory, or a combination thereof.

The operating system 252 may be implemented by any conventional operating system such as z/OS® (Registered Trademark of International Business Machines Corporation), MVS® (Registered Trademark of International Business Machines Corporation), OS/390® (Registered Trademark of International Business Machines Corporation), AIX® (Registered Trademark of International Business Machines Corporation), UNIX® (UNIX is a registered trademark of the Open Group in the United States and other countries), WINDOWS® (Registered Trademark of Microsoft Corporation), LINUX® (Registered trademark of Linus Torvalds), Solaris® (Registered trademark of Sun Microsystems Inc.) and HP-UX® (Registered trademark of Hewlett-Packard Development Company, L.P.).

In various embodiments, the present invention may be implemented as a method, apparatus, computer program product or article of manufacture using standard programming and/or engineering techniques to produce software, firmware, hardware, or any combination thereof. Various embodiments of the invention are implemented in software, which includes and is not limited to firmware, resident software, and microcode.

Furthermore, various embodiments of the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium comprises a semiconductor or solid state memory, magnetic tape, a removable computer diskette, a random access memory (RAM), a read-only memory (ROM), a rigid magnetic disk and an optical disk. Current examples of optical disks comprise compact disk - read only memory (CD-ROM), compact disk-read/write (CD-R/W) and digital video disk (DVD). The medium also encompasses transmission media, such as the network transmission line and wireless transmission media. In addition, the software in which various embodiments are implemented may be accessible through the transmission medium, for example, from a server over the network. Those skilled in the art will recognize that many modifications may be made to this configuration without departing from the scope of the present invention.

The exemplary computer system 220 illustrated in FIG. 12 is not intended to limit the present invention. Other alternative hardware environments may be used without departing from the scope of the present invention.

In an alternate embodiment, the web server also comprises the functionality of the network sniffer and the agent. In another alternate embodiment, the network sniffer and agent are combined.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

What is claimed is:

1. A computer-implemented method of identifying jitter in a multimedia datastream comprising packets which are sent from a web server in a web server computer to a client computer, comprising:
computing, in said web server computer, packet intervals associated with said packets which are sent from said web server; and
determining, in said web server computer, whether jitter is occurring at said client computer receiving said packets based on said packet intervals.

2. The method of claim 1 further comprising:
providing, by a network sniffer at said web server computer, timestamps indicating times that said network sniffer received said packets, wherein said computing said packet intervals is based on said timestamps.

3. The method of claim 1 wherein said determining determines that jitter is occurring in response to at least one of said packet intervals exceeding a jitter threshold.

4. The method of claim 3 further comprising:
determining said jitter threshold.

5. The method of claim 1 further comprising:
displaying a jitter indicator in response to determining that jitter is occurring.

6. The method of claim 1 further comprising:
determining a jitter rate based on said packet intervals.

7. The method of claim 6 further comprising:
displaying said jitter rate.

8. The method of claim 6 wherein said jitter rate is per-packet.

9. The method of claim 6, further comprising:
receiving, by said web server computer, a request for said jitter rate; and
providing said jitter rate.

10. The method of claim 1 wherein said jitter is manifest jitter.

11. A computer program product comprising a computer-usable medium having a computer readable program, wherein the computer readable program when executed on a computer causes the computer to:
compute packet intervals associated with packets of a multimedia datastream which are sent by a web server on said computer to a client; and
determine whether jitter is occurring at said client receiving said packets based on said packet intervals.

12. The computer program product of claim 11 wherein the computer readable program when executed on the computer further causes the computer to:
receive timestamps indicating times that a network sniffer received said packets, wherein said packet intervals are computed based on said timestamps.

13. The computer program product of claim 11 wherein said jitter is determined to be occurring in response to at least one of said packet intervals exceeding a jitter threshold.

14. The computer program product of claim 11 wherein the computer readable program when executed on the computer further causes the computer to:
determine said jitter threshold.

15. The computer program product of claim 11 wherein the computer readable program when executed on the computer further causes the computer to:
display a jitter indicator in response to determining that jitter is occurring.

16. The computer program product of claim 11 wherein the computer readable program when executed on the computer further causes the computer to:
determine a jitter rate based on said packet intervals.

17. The computer program product of claim 16 wherein the computer readable program when executed on the computer further causes the computer to:
display said jitter rate.

18. The computer program product of claim 17 wherein said jitter rate is per-packet.

19. The computer program product of claim 17 wherein said jitter rate is per-unit-time.

20. The computer program product of claim 17 wherein said jitter rate is based on a number of times jitter occurred in at least a portion of said packet intervals.

21. The computer program product of claim 11 wherein the computer readable program when executed on the computer further causes the computer to:
provide a jitter rate indicator in response to said jitter rate exceeding a predetermined jitter alert threshold.

22. The computer program product of claim 11 wherein the computer readable program when executed on the computer further causes the computer to:
receive a request for said jitter rate; and
provide said jitter rate.

23. A computer system, comprising:
a web server that sends a multimedia datastream comprising packets to a client computer; and
an agent in said web server computer that computes packet intervals associated with said packets, and that determines whether jitter is occurring at said client computer receiving said packets based on said packet intervals.

24. The computer system of claim 23 further comprising:
a network sniffer that provides timestamps indicating times that said network sniffer received said packets, wherein said packet intervals are computed based on said timestamps.

25. The computer system of claim 23 wherein said agent determines that jitter is occurring in response to at least one of said packet intervals exceeding a jitter threshold.

26. The computer system of claim 23 further comprising:
a jitter indicator that is displayed in response to determining that jitter is occurring.

27. The computer system of claim 23 further comprising:
a jitter rate that is determined based on said packet intervals.

28. The computer system of claim 27 wherein said jitter rate is per-packet.

29. The computer system of claim 27 wherein said jitter rate is per-unit-time.

30. The computer system of claim 27 wherein said jitter rate is based on a number of times jitter occurred in at least a portion of said packet intervals.
